(19) United States
(12) Patent Application Publication
(10) Pub. No.: US 2007/0019096 A1
(43) Pub. Date: Jan. 25, 2007

(54) Photographing system providing image data to an external display apparatus

(75) Inventor: Tadaaki Yoneda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Corporation

(21) Appl. No.: 11/483,755

(22) Filed: Jul. 11, 2006

Related U.S. Application Data
(62) Division of application No. 10/120,563, filed on Apr. 12, 2002.

(30) Foreign Application Priority Data
Apr. 18, 2001 (JP) 119337/2001

(51) Int. Cl. H04N 5/222

(52) U.S. Cl. 348/333.01

(57) ABSTRACT

A photographing system includes an image acquisition device for acquiring an image data, an image data provision device for providing the image data, an interface connectable to an external display apparatus, and a controller for controlling the external display apparatus. When the interface is connected to the external display apparatus, the controller is capable of controlling the external display apparatus. Additionally, the image data provision device provides the acquired image data to the external display apparatus through the interface.

This application is a Divisional of application Ser. No. 10/120,563, filed Apr. 12, 2002, which claims the benefit of priority to Japanese Patent Application No. 2001-119337, filed Apr. 18, 2001, the entire disclosure of which is incorporated herein by reference.

### BACKGROUND OF THE INVENTION

The present invention relates to a photographing system including an electronic camera such as a digital still camera, which can A/D convert signals of still-images imaged with imaging devices such as CCD into digital image signals and can store them in external recording media such as IC memory cards, more particularly to a photographing system such as an electronic camera which has external interface means such as USB to connect external devices.

Electronic cameras have become widespread which can convert optical images of subjects into electronic image signals through imaging devices and can store them in an external memory which corresponds to a photographic film. Such electronic cameras can send electronic image signals stored in the external memory to a built-in LCD monitor or an external TV which can reproduce the image signals. The electronic cameras can also send the image signals through an external interface or memory card to a personal computer which can temporarily display the images on its high definition monitor. The personal computer can print out the image data. The electronic cameras can send the image data through the memory card directly to a printer for hardcopy.

FIGS. 21 and 22 show a schematic diagram of a traditional digital still camera which is one type of electronic cameras. In the figures, a photographer can actuate the digital still camera 100 by operating a switch 101 on the camera body. The photographer can compose shots by looking through a finder 112 or looking at a built-in LCD 108 before pressing a release button 102. The pressed release button 102 allows, if necessary, a strobe 105 to flash to give a right amount of light to the subject. The subject is then imaged through a photographing lens 106 on a not shown internal imaging device. The images imaged on a CCD are read out as electrical signals. The signals are subjected to required signal processing such as colorization signal processing before being stored in a detachable memory card inserted in a slot 104. The detachable memory card can be exchanged by pressing a button 103 to pop the memory card out of the memory slot 104. Every pressing of a LCD display button 110, a LCD 108 turns on/off so that the built-in LCD 108 can be left off for power saving if necessary.

The operation condition of the digital still camera can be changed by pressing a menu button 111 to display a digital still camera operation setting menu on the built-in LCD 108. The operation condition can be set on the menu with a five-way button 109 (up, down, right, left, and center pressing). FIG. 23 shows an example of the operation setting menu. The setting includes, from the top of the main menu on the left hand side, date setting for auto date, image quality setting, image size setting, favorite LCD display setting, continuous shooting condition setting, stored image information setting, favorite white balance setting, auto focus area selection setting, auto exposure mode setting, and post view reproduction setting. In FIG. 23, the image size setting is selected by pressing up and down the five-way button 109 and a sub menu of selectable image sizes is displayed on the right hand side by pressing right the five-way button 109. In FIG. 23, an image size of 1600×1200 pixels is selected.

Recently, USB interface has become widespread as an external interface for connecting the digital still camera to the personal computer. The USB (Universal Serial Bus) interface allows hot-socketing (inserting and removing the USB connecter from the personal computer while power is applied) with the external devices. It also allows data communication within a 12 Mbps high speed band and can transmit higher capacity image data in a short time than the traditional asynchronous serial interface such as RS-232C. Thus, the USB interface has become a mainstream interface for low- and medium-speed peripheral equipments for a personal computer. In addition, new electronic devices for peripheral equipments have recently become widespread, which include a host function which is only included so far in the personal computer. Having the host function, very convenient peripheral equipments have become available.

The digital still camera 100 shown in the FIG. 21 can connect with a not shown personal computer through a USB cable connected to a USB interface connector 107. Recently, compact, low cost, and high pixels digital still cameras have been commercially available because of recent development of high pixels CCD imaging devices and technological advance of development of components for miniaturization. Such components for miniaturization include imaging devices integrated with a lens optical system or peripheral equipments, a battery with a high energy density, a group of control switches, a liquid crystal for display, and memory cards. In this miniaturization of the photographing system, when images taken with the photographing system are displayed on a compact LCD on the photographing system, they are difficult to observe. A high pixels large LCD can solve the above problems related to the display. However, a large display area is needed in a limited surface area of the camera body size. Thus, the smaller operation components such as buttons will be needed and the camera operability may be decreased, or the larger size of the camera itself will be needed, which will result in disadvantages in operability or portability.

Recently, images displayed on the personal computer have often been used for making presentations. In addition, many compact and relatively low cost liquid crystal projectors are commercially available to allow more audience to see the images. Most of current projectors need to be connected to a video output terminal of the personal computer. Thus, to see the images taken with the digital still camera using such a projector, the image data needs to be temporarily stored in the personal computer.

Alternatively, the digital still camera needs to have a video circuit and connector suitable for the video terminal of the personal computer to project the images.

### SUMMARY OF THE INVENTION

To solve the above mentioned problems, it is a first object of the present invention to provide a photographing system which can keep the user operability and visibility under miniaturized conditions. It is a second object of the present invention to provide a photographing system which can display images on a display means in addition to the display means on the camera without through the personal computer.

(Means for Solving the Problems)

(1) A photographing system comprising the following configuration: an acquisition means for acquiring an image data; a processing means for processing the image data; an image data provision means for providing the image data; and an interface connectable to an external display apparatus, wherein when the interface is connected to the external display apparatus, the processing means obtains from the display apparatus information on displayable image and processes the image data acquired by the acquisition means according to the information, and the image data provision means provides the processed image data.

In this configuration, the image data of the image which is acquired by photographing with the photographing system or by receiving external image signals is processed into an image data applicable to the external display and is sent to the unit. Thus, an adequate image can be displayed on the display apparatus.

The display apparatus according to the present invention includes a unit of a configuration which can display the image by itself as well as a unit which allows other units to display the image. For example, a unit for projecting the image to allow other units to display the image, such as a projector, is included.

(2) A photographing system according to (1), wherein the display apparatus displays an image according to the image data provided by the image provision means.

(3) A photographing system according to (1) or (2), wherein the information on the displayable image includes information on at least one of resolution and color number in image formation by the display apparatus, and further comprising the following configuration: a display means (device) for displaying the information.

In this configuration, the operator of the photographing system can advantageously grasp the settable information of the display apparatus.

(4) A photographing system according to (3), wherein further comprising the following configuration: a selection means (selector) for selecting at least one of a plurality of resolutions and color numbers in the image formation, when the information on the displayable image includes a plurality of at least one of the resolution and color number in image formation provided from the display apparatus.

If the photographing system has the selection means for selecting at least one of a plurality of resolutions arid color numbers in the image formation, when the information on the displayable image includes a plurality of at least one of the resolution and color number in image formation provided from the display apparatus, for example, the operator of the photographing system can conveniently select at least one of the resolutions and color numbers in the image information as desired using the selection means, with looking at the display means.

(5) A photographing system according to one of (1) to (4), wherein the display means displays information on the setting of the display apparatus according to the information provided from the display apparatus.

In such a configuration, the operator can check at hand the information on the setting of the display apparatus.

(6) A photographing system according to one of (1) to (5), wherein further comprising the following configuration: a control switch for changing the setting of the display apparatus.

In such a configuration, the setting of the projector can more advantageously be changed from the photographing system side.

(7) A photographing system according to one of (1) to (6), wherein the display apparatus is integrated.

In this case, the display apparatus is preferably particularly a display apparatus of a projection type, such as a projector. The display apparatus of the projection type can prevent an enlarged photographing system while keeping a good usability of the system.

(8) A photographing system according to one of (1) to (7), wherein the display apparatus is more preferably a projector.

(9) A photographing system comprising the following configuration: an acquisition means for acquiring an image data; a display means capable of displaying more than one image according to the acquired data; a determination means for determining one of the data displayed on the display means; an image data provision means for providing the image data; and an interface connectable to an external display apparatus, wherein when the interface is connected to the external display apparatus, the image data provision means provides to the display apparatus an image data corresponding to the image specified by the determination means.

(10) A photographing system comprising the following configuration: an acquisition means for acquiring an image data; a display means capable of displaying an image according to an image data; an image data provision means for providing an image data; and an interface connectable to an external display apparatus, wherein when the interface is connected to the external display apparatus, the image data provision means can provide an image data to the external display apparatus such that the display apparatus has a different display state from that of the display means.

In the configuration of (9) or (10), for example, index displaying more than one images on the photographing system, determining one of them with the determination means, and projecting the determined image from the projector, thus the desired image can conveniently be projected despite the order of the stored image data.

(11) A photographing system according to (9) or (10), wherein the display apparatus displays an image according to the image data provided by the image provision means.

(12) A photographing system according to one of (9) to (11), wherein the display apparatus is integrated.

In this case, the display apparatus is preferably particularly a display apparatus of a projection type, such as a projector. The display apparatus of the projection type can prevent an enlarged photographing system while keeping a good usability of the system.

(13) A photographing system according to one of (9) to (12), wherein the display apparatus is preferably a projector.

(14) A photographing system comprising: an acquisition means for acquiring an image data; an image data provision means for providing an image data; and an interface connectable to an external display apparatus, wherein when the interface is connected to the external display apparatus, the image data provision means provides an image data to the display apparatus and provides to the display apparatus an image data corresponding to the next image to be displayed on the display apparatus.

In this configuration, for example, when the user wants to switch from the currently projected image to another image which is located apart in the storing order of the image data, the image data provision means can predict the next image to be projected and previously send the image data to the display apparatus so that the time for switching the image can be reduced.

(15) A photographing system according to (14), wherein in switching from the currently displayed image to another image, the image data provision means preferably provides to the projector an image data corresponding to the next image to be displayed on the display apparatus.

(16) A photographing system according to (14) or (15), wherein further comprising a control switch and the image data provision means preferably previously determines the next image to be displayed on the display apparatus according to the operation condition of the control switch.

(17) A photographing system according to one of (14) to (16), wherein the display apparatus is integrated.

In this case, the display apparatus is preferably particularly a display apparatus of a projection type, such as a projector. The display apparatus of the projection type can prevent an enlarged photographing system while keeping a good usability of the system.

(18) A photographing system according to one of (4) to (17), wherein the display apparatus is preferably a projector.

(19) A photographing system comprising the following configuration: an acquisition means for acquiring an image data; an image data provision means for providing an image data; an interface connectable to an external display apparatus; and a control means for controlling a connected external display apparatus, wherein the control means can control the external display apparatus when the interface is connected to the display apparatus, and the image data provision means provides the acquired image data to the display apparatus.

(20) A photographing system comprising: an acquisition means for acquiring an image data; an image data provision means for providing an image data; an interface connectable to an external display apparatus; and a control means for issuing a control command which controls a connected external display apparatus, wherein the interface sends to the external display apparatus the image data provided by the image data provision means and the control command issued by the control means, when the interface is connected to the display apparatus.

In the configuration of (19) or (20), the photographing system can serve as an image data provision means as well as a controller for the connected display apparatus, which can remotely control the display apparatus with the control means.

(21) A photographing system according to (19), wherein-the control means can preferably control the connected external display apparatus so that the image displayed on the external display apparatus is enlarged or reduced. The control means may turn on/off the display apparatus, particularly a projector light.

(22) A photographing system according to (20), wherein the control means can preferably issue a control command for scaling the image on the display apparatus. The command may turn on/off the display apparatus, particularly a projector light.

(23) A photographing system according to one of (19) to (22), wherein the display apparatus is integrated.

In this case, the display apparatus is preferably particularly a display apparatus of a projection type, such as a projector. The display apparatus of the projection type can prevent an enlarged photographing system while keeping a good usability of the system.

(24) A photographing system according to one of (19) to (23), wherein preferably further comprising the following configuration: a zoom switch for directing a zoom shot, wherein when the interface is connected to the external display apparatus, the control means controls the display apparatus to allow the optical system of the display apparatus to move, in response to the zoom shot command from the zoom switch.

(25) A photographing system according to one of (19) to (24), wherein the display apparatus is preferably a projector. Commercially available digital still cameras have capability of photographing still images of high pixels and additional capabilities such as moving images recording capability and audio capability. Thus, the settable items have increased to conform to the capabilities. For example, the items include a setting of switching to the moving images mode or the number of pixels incorporated in the moving image, a setting of the frame rate of the moving images, or an audio volume setting.

Conventionally, the operation of the digital still camera is set by operating the user control button on the camera to select the desired menu with looking at the images displayed on the built-in LCD of the camera or the output images on TV. The built-in LCDs of the digital still cameras have decreased their sizes as the miniaturization of the cameras. Thus, the cameras are not easy to operate for particularly the users such as older people with weak eyesight. In the output images on TV, the displayed subjects such as the menus or icons are enlarged, but the images equivalent to the images displayed on the built-in LCD (for example, thumbnail images) have lower sharpness, which may result in inconvenient operation.

Recently, images displayed on the personal computer have often been used for making presentations. In addition, many compact and relatively low cost liquid crystal projectors are commercially available to allow more audience to see the images. Most of current projectors need to be connected to a video output terminal of the personal computer. Thus, to see the images taken with the digital still camera using such a projector, the image data needs to be temporarily stored in the personal computer. Alternatively, the digital still camera needs to have a video circuit and connector suitable for the video terminal of the personal computer to project the images.

With the recent high performance of the digital still cameras, the images taken with the cameras have higher image pixels and qualities, and the images displayed on the camera also have higher resolutions and qualities. However, the control switches or the image areas for displaying the operation settings have become smaller. Thus, the menu contents displayed in the small screen have increased and complicated, the control buttons to control the menu have become difficult to operate, and the reproduced images can not be sufficiently identified.

Increasing the number of the control button of hardware to obtain the high performance of the digital still camera will confuse the user operation and increase the number of the control button on the digital camera. Thus, disadvantageously, the operability or the miniaturization will be retarded and the design flexibility will be limited. Conversely, a deep hierarchical menu including the less frequently used capabilities or a menu including a number of items will bury the frequently used necessary capabilities in the hierarchy, which may result in a complicated menu.

As only for the display, a high pixels large LCD can solve the above problems related to the display. However, a large display area is needed in a limited surface area of the camera body size. Thus, the much smaller operation components such as buttons will be needed and the camera operability may be decreased, or the larger size of the camera itself will be needed, which will result in disadvantages in operability or portability. This is ditto for the control button.

Preferable configuration to solve the above problems includes the following.

(26) An electronic camera comprising: a processing means for performing predetermined processing; and an interface connectable to at least one of an external mouse, keyboard, and projector, wherein the processing means performs the predetermined processing according to a signal from at least one of the externally connected mouse, keyboard, and projector. In this configuration, even if the small control switch is provided on the electronic camera to be operated to allow the processing means to perform the predetermined processing, the externally connected mouse or keyboard can conveniently be used to do the same operation. The control switch can be removed from the electronic camera for some processing by the processing means (for example, color balance correction which is seldom performed). This can miniaturize the electronic camera or simplify the menu. When the electronic camera according to the present invention is connected to the projector, the processing means can detect the connected projector according to the information sent from the projector. The processing means can then send image data as the predetermined processing and the projector can project the image.

(27) An electronic camera according to (26), wherein further comprising: a display means for displaying information on the processing by the processing means and a cursor movable in response to the signal from at least one of the external mouse, keyboard, and projector which is connected to the interface, wherein the processing means performs processing corresponding to the information indicated by the cursor. In this configuration, the operating procedure for the electronic camera is similar to that for the personal computer, so that a beginner on the camera can readily operate it.

(28) The predetermined processing performed by the processing means is preferably shutter release operation, although the processing is not limited to it and can include various setting changes.

(29) An electronic camera according to (27) or (28), wherein the display means can change the display of the processing by the processing means according to the mode setting of the electronic camera.

In this configuration, a large and easily visible display can advantageously be provided.

(30) An electronic camera according to one of (26) to (29), wherein the display means can change the display of the processing by the processing means according to the externally connected mouse, keyboard, and projector. In this configuration, the display means can provide an easily visible display.

(31) The interface can supply power from a battery loaded in the electronic camera to at least one of the externally connected mouse and keyboard, and the detection level of the remaining charge of the built-in battery in the electronic camera (for example, a voltage check level as a threshold level) when the interface connected to at least one of the external mouse and keyboard is preferably changed from the detection level when the interface connected to neither the external mouse nor the keyboard.

(32) An electronic camera according to (31), wherein the detection level of the battery remaining is preferably changed such that the threshold level to compare with the battery voltage is higher.

So called USB type interface can supply power to the external equipment which is connected to the interface. The power is supplied from the built-in battery unless an external power is supplied to the electronic camera. The electronic camera can generally display the battery remaining by detecting the voltage of the built-in battery. With the battery voltage below the threshold level, the normal operation can not be expected for the electronic camera, so that the power supply from the electronic camera will be stopped. When the interface is connected to at least one of the external mouse and keyboard, it is considered that the power is supplied to the external equipments and the battery consumption will be higher. Therefore, if the same threshold level is to be compared with the battery voltage, unexpected load due to the external mouse and the like may cause a power supply shortage and the electronic camera may become uncontrollable. Thus, when the interface is connected to at least one of the external mouse and keyboard, the threshold level to be compared with the battery voltage to detect the remaining charge of the built-in battery in the electronic camera is higher than the threshold level when the interface is connected to neither the external mouse nor the keyboard. This allows the processing such as early power shutdown for the rapid battery depletion.

(33) An electronic camera according to (32), wherein the processing means preferably stops the power supply from the battery if the battery voltage is judged to be below the threshold level.

(34) An electronic camera according to one of (31) to (33), wherein when the interface is connected to at least one of the external mouse and keyboard, and the electronic camera is supplied with power from an external power supply, the threshold level is not changed.

In this configuration, when the electronic camera is supplied with power from an external power supply, built-in battery exhaustion need not be taken into account.

(35) An electronic camera according to one of (31) to (34), wherein when power is not supplied to any external devices, the threshold level is not changed.

(36) An electronic camera according to (35), wherein the external device is preferably an external projector connected to the interface.

This is because the external projector often has its own power supply and needs no power supply from the electronic camera.

(37) An electronic camera according to one of (26) to (36), wherein when the interface is connected to both the external mouse and keyboard, which of two signals from the mouse and keyboard is a high priority is determined according to the connection condition.

By determining which of two signals from the mouse and keyboard is a high priority according to the connection condition (for example, a location of a port to plug in), a confusion of the control due to the two simultaneous signals will be prevented.

### BRIEF DESCRIPTION OF THE DRAWINGS

FIG. 1 shows a schematic diagram of a digital still camera as an example of an electronic camera suitable for the implementation of the present invention.

FIG. 2 shows a schematic diagram of a digital still camera having a USB mouse connected to its host port.

FIG. 3(a) shows a schematic diagram of a perspective view of a camera used in the present invention

FIG. 3(b) shows a schematic diagram of a rear view of a camera used in the present invention

FIG. 4 shows a schematic diagram of a digital still camera having a keyboard connected to its host port.

FIG. 5 shows a schematic diagram of a menu change when a USB board is connected to the camera body.

FIG. 6 shows a schematic diagram of functions changes in each operation mode of the digital still camera with an external USB mouse connected to it.

FIG. 7 shows a schematic diagram of a priority level when equipments are connected to two ports of USB host function.

FIG. 8 shows a schematic diagram of an example of a connection circuit for a USB host.

FIG. 9 shows a schematic diagram of an example of a connection circuit for a USB function.

FIG. 10 shows a schematic diagram of an internal configuration of a projector 60 having USB connection capability according to the present invention.

FIG. 11 shows a schematic diagram of an example of a connector structure for USB host.

FIG. 12 shows a schematic diagram of an example of a connector structure for USB function.

FIG. 13(a) shows a schematic diagram of index images displayed on a built-in LCD 28 of the digital still camera 20.

FIG. 13 (b) shows a schematic diagram of an image in FIG. 13(a) projected by the projector 60.

FIG. 14 shows a schematic diagram of a digital still camera 20 with which a projector 60 and a keyboard 50 are connected.

FIG. 15 shows a schematic diagram of an automatic change of a setting menu displayed on a built-in LCD when a projector is only connected to the digital still camera.

FIG. 16 shows a schematic diagram of a combination of voltage check levels of a digital still camera battery changed in accordance with the type of externally connected equipments.

FIG. 17 shows a schematic diagram of a flowchart for changing a battery detection level according to information on a connected external equipment.

FIG. 18 shows a schematic diagram of a flowchart of control of acquiring information on displayable resolution and color number from a projector, when the projector is connected to the digital still camera and changing a menu displayed according to the information.

FIG. 19 shows a schematic diagram of a flowchart of control of detecting a projector connected to the digital still camera, and shifting to a reproduction mode in a camera mode and changing a zoom button assignment to a projector zoom command.

FIG. 20 shows a schematic diagram of a flowchart for predicting image data of the next image to be projected by the projector and transmitting the data.

FIG. 21 shows a schematic diagram of a perspective view of a digital still camera of the prior art.

FIG. 22 shows a schematic diagram of a rear view of a digital still camera of the prior art.

FIG. 23 shows a schematic diagram of an example of a display on LCD of a digital still camera of the prior art.

FIG. 24 shows a schematic diagram of a connection circuit for a USB function, including a switching means 72 and connector 73.

### DETAILED DESCRIPTION OF THE PREFERRED EMBODIMENT

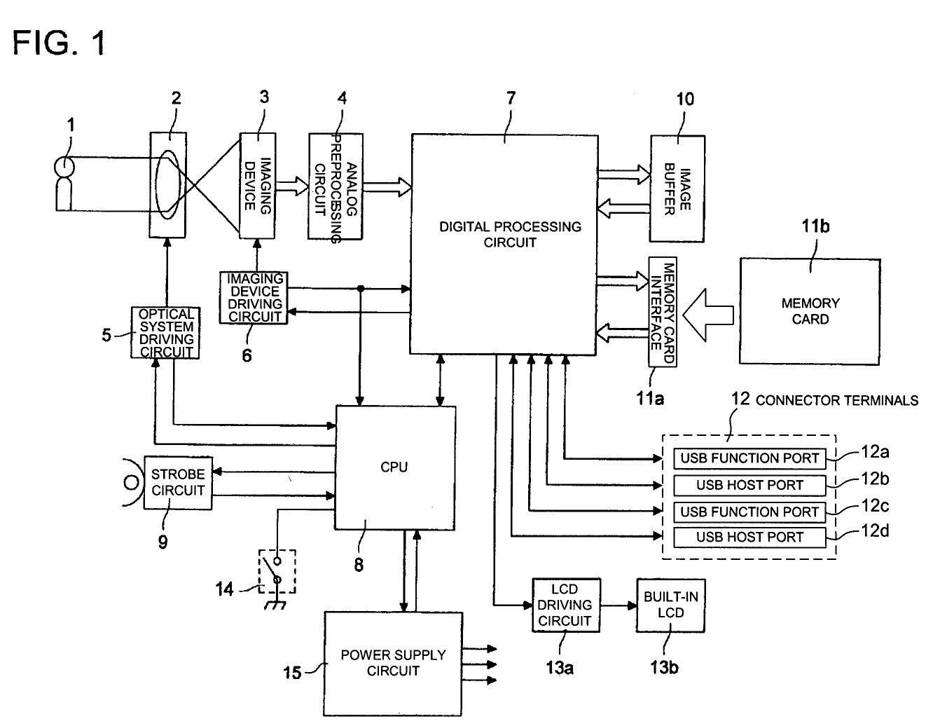

The present invention will be described below in more detail referring to examples. FIG. 1 shows a schematic diagram of a digital still camera as an example of an electronic camera of a photographing system suitable for the implementation of the present invention. Optical information from the subject 1 is imaged on a photoreceptor surface of an imaging device (acquisition means) such as CCD through an optical system 2. Optical auto focusing or zooming and auto exposure are performed by CPU 18 for sequence control of the digital still camera via an optical system driving circuit 5. The subject optical information which is imaged on the photoreceptor surface of the imaging device 3 is converted into an electronic image data which is readout controlled by a transmission pulse from an imaging device driving circuit 6 including a timing generation circuit. In an analog preprocessing circuit 4, a subject image signal is retrieved from the read out electronic image data of the imaging device and the subject image data is A/D converted to generate a digital image signal. The digital image data is subjected to color signal processing or luminance signal processing in a digital processing circuit 7.

If the signal is read out from the imaging device in draft mode, the digital image data is reduced in the digital processing circuit 7 to an image size suitable for a display size of a built-in LCD (display means) 13b. The digital image data is then sent to a LCD driving circuit 13a as a preview image data in a form of, for example, an analog RGB signal. If the signal is read out from the imaging device in high definition mode, the digital image data is subjected to color signal processing or luminance signal processing in the digital processing circuit 7 and then temporarily stored in an image buffer 10 of SDRAM and the like. The image data stored in the SDRAM is read out again by the digital processing circuit 7 where the data is subjected to JPEG compression processing, and is then stored in a memory card 11b via a memory card interface 11a.

Such a series of control operations is decided by sending from CPU 8 to the digital processing circuit 7, collected values such as photometric measurements, focusing values, and color temperature from the image data obtained via the imaging device 3, and information input by operation of an input key 14, and power supply conditions of a power supply circuit 15. The control operations are performed by activating the imaging device driving circuit 6, optical system driving circuit 5, strobe circuit 9, and power supply circuit 15.

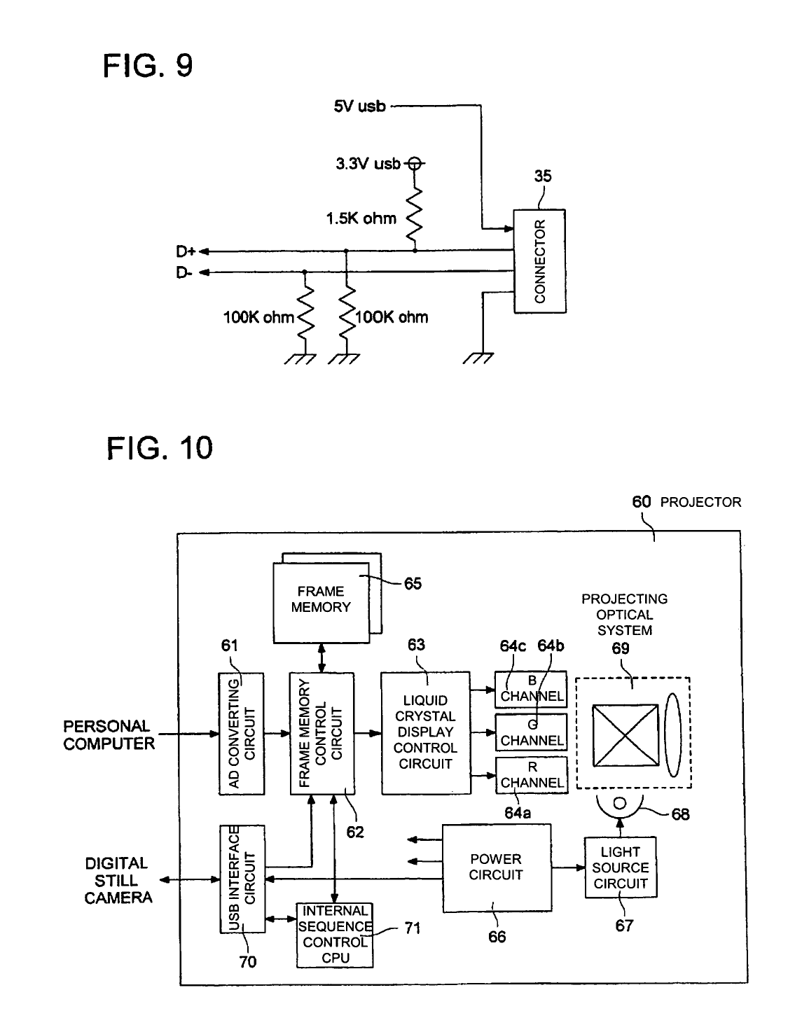

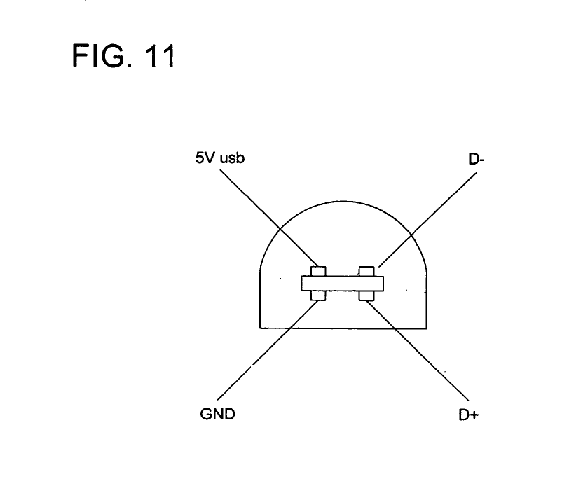

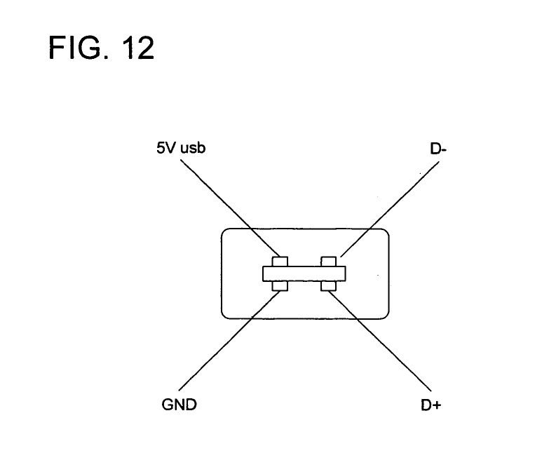

Because of recent advance of the semiconductor integration, many of the digital processing circuits 7 as an image data provision (supply) means have inside an external interface circuit. In FIG. 1, many of the external interface circuits such as USB function or USB host are provided in the digital processing circuit 7 and connected with some of connector terminals 12. In FIG. 1, the connector terminals 12 have two ports for the USB host and two ports for the USB function, four ports in total. The ports for USE host are 12b and 12d, and the ports for USB function are 12a and 12c. FIG. 8 shows an example of a connection circuit for a USB host, and FIG. 9 shows an example of a connection circuit for a USB function. The connector 34 in FIG. 8 is an example of a connector at the USB host side. The connector structure is shown in FIG. 11. The connector 35 in FIG. 9 is an example of a connector at the USB function side. The connector structure is shown in FIG. 12.

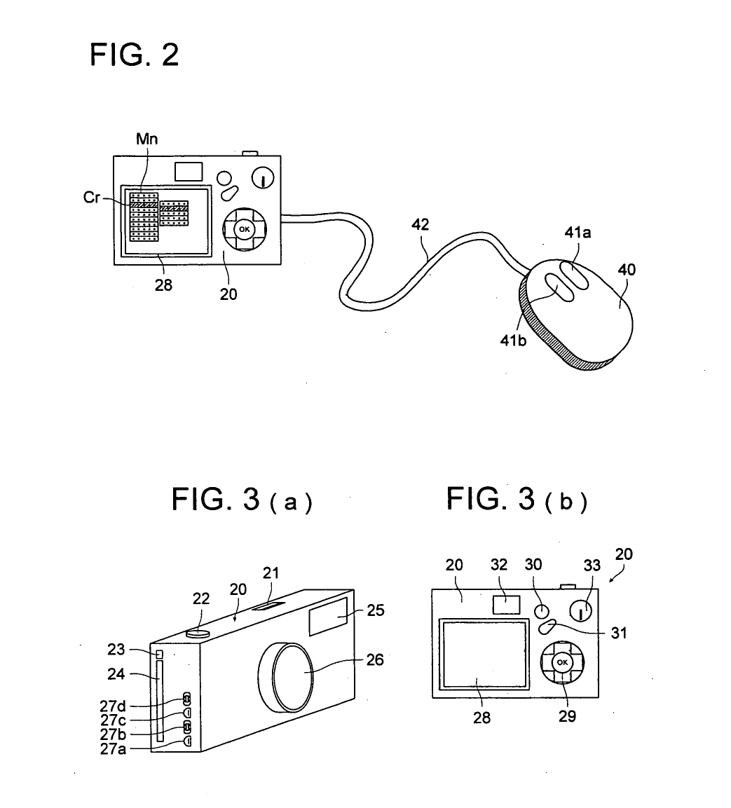

FIG. 2 shows a schematic diagram of a digital still camera having a USB mouse connected to its host port. The mouse body 40 connected to the digital still camera 20 via a cable 42 is equipped with a mouse right button 41a and mouse left button 41b thereon. An externally connected mouse is only explained here, although a track ball and track pad can function similarly to the mouse and are included in the mouse. The scope of the present invention is not limited by their differences in form. The track pad is preferably incorporated in the digital still camera body. Thus, the track pad connected internally to the camera via a general-purpose interface bus such as USB is also within the scope of the present invention. The connection can be changed in the setting menu to obtain the same effect. With the USB mouse connected, the operator can look at the built-in LCD 28 of display means displaying a menu Mn (information on the processing) and cursor Cr, and can right click on the mouse to allow the digital still camera 20 to do photometric measurement and focusing. The operator can then left click for the shutter release. Thus, the USB mouse can serve as a remote controller. In this case, the photometric measurement, focusing, and shutter release are the predetermined processing to be performed by the digital processing circuit 7. The content of the menu Mn can be changed according to the mode set by the camera.

FIGS. 3(a) and 3(b) show a schematic diagram of the camera used in the present invention. FIG. 3(a) shows a perspective view of the camera, and FIG. 3(b) shows a rear view of the camera. In the figures, the photographer can actuate the digital still camera by operating a switch 21 on the camera body. The photographer can compose shots by looking through a finder 32 or looking at a built-in LCD 28 (display means) before pressing a release button 22. The pressed release button 22 allows, if necessary, a strobe 25 to flash to give a right amount of light to the subject. The subject is then imaged through a photographing lens 26 on a photoreceptor surface of the internal imaging device 3 (FIG. 1). The images imaged on the photoreceptor surface of the imaging device 3 are read out as electrical signals. The signals are subjected to required signal processing such as colorization signal processing before being stored in a detachable memory card inserted in a slot 24. The detachable memory card can be exchanged by pressing a button 23 to pop the memory card out of the memory slot 24. Every pressing of a LCD display button 30, the LCD 28 turns on/off so that the built-in LCD 28 can be left off for power saving if necessary. The operation of a zoom button 33 can actuate a zoom lens 26. The operation of a mode change switch 31 can change a photographing mode and the like.

In the present embodiment, terminals 27b and 27d are the ports for the USB host and they correspond to the terminals 12b and 12d in FIG. 1, respectively. Terminals 27a and 27c are the ports for the USB function and they correspond to the terminals 12a and 12c in FIG. 1, respectively.

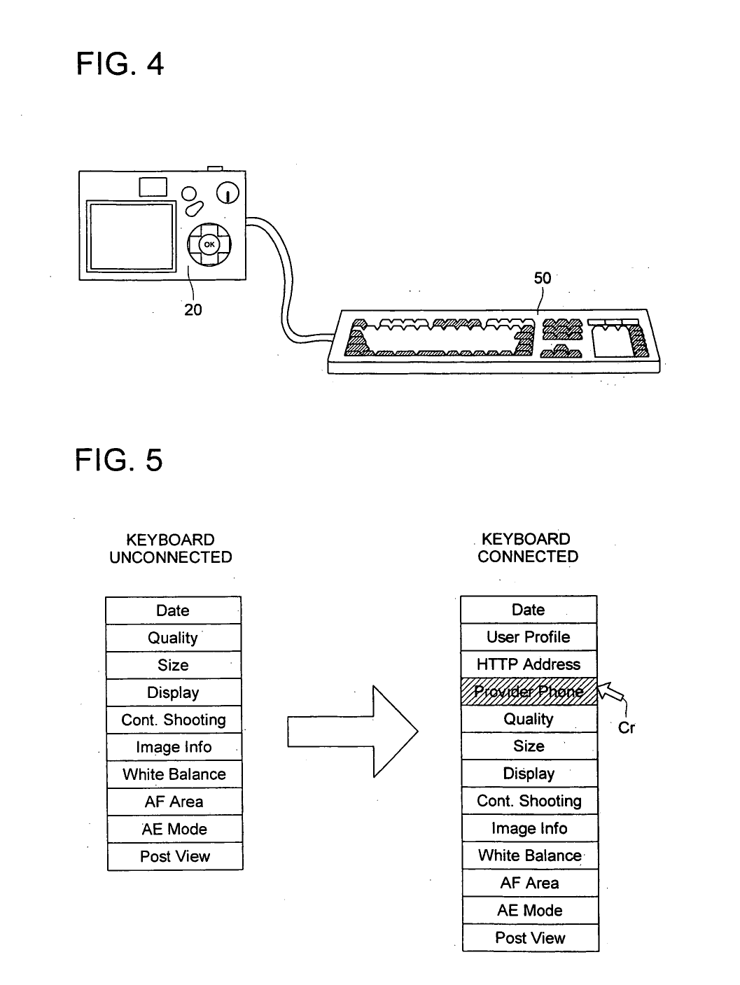

FIG. 4 shows a schematic diagram of a digital still camera having a USB keyboard connected to its host port. Through the keyboard 50, characters, numerics, and symbols can be entered. The configuration of the keyboard 50 is well known and will not be described in detail below.

FIG. 5 shows a schematic diagram of a menu change displayed on the built-in LCD 28 when a USB board is connected to the camera body. The left hand side is the menu for the digital still camera alone (no keyboard connected). With the keyboard connected, as shown on the right hand side, are added User Profile setting to revise the owner of the camera, Provider Phone setting to set a phone number of a provider to connect first when connecting the camera via a USB modem with an external network, and HTTP Profile setting to set an address for connecting the camera via USB network card or USB modem with a specific Web server. User Profile setting is to set personal information and needs password or kanji characters to be entered and displayed. Thus, this setting can preferably appear when a high definition projector in addition to the keyboard is connected to the camera. One of these menus can be selected by operating the connected mouse 40 or keyboard 50 to move the cursor Cr.

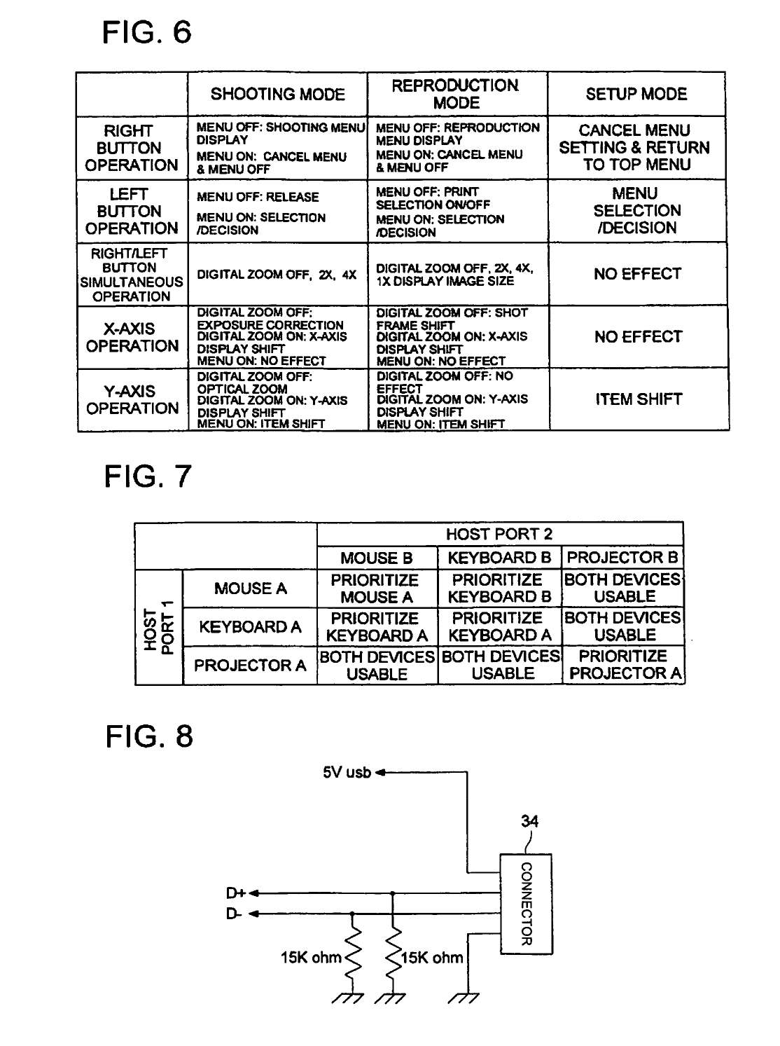

FIG. 6 shows a schematic diagram of functions changes in each operation mode of the digital still camera with an external USB mouse connected to it. As described above, the operation mode of the digital still camera can be changed with the mode change switch 31 shown in FIG. 3. This also changes the display of the built-in LCD 28 as shown in FIG. 6. Looking at the display, the user can operate the USB mouse to allow the digital processing circuit 7 to perform different processings as shown in FIG. 6.

FIG. 7 shows a schematic diagram of a priority level when equipments are connected to two ports of USB host function. Such a priority level can prevent operation confusion when, for example, both the mouse and keyboard are connected.

In general, the external equipment such as USB type mouse or keyboard which is connected to the camera is supplied with 5V from the host side. Thus, there is more load on the power supply than when the digital still camera is only operated and the power supply voltage is decreased. If the power supply is the built-in battery, the energy of the battery will be consumed faster than in the normal operation. Therefore, with the same battery detection level as that when the digital still camera is only operated, the battery in a sufficient energy state may have a power level which unexpectedly falls below the detection level, to cause a shutdown, or may have an indicated level which abruptly changes from the maximum state to the empty battery state. To solve such a problem, the battery detection level is preferably changed according to the dependence of the externally connected equipments on the power supply. Therefore, in the digital still camera according to the present invention, the battery detection level is changed as follows.

FIG. 16 shows a schematic diagram of a combination of voltage check levels of a digital still camera battery changed in accordance with the type of the externally connected equipments. In FIG. 16, the “unconnected” state shows the battery check levels in the solo operation of the digital still camera. When the mouse is detected to the digital still camera, the digital processing circuit 7 detects it and decreases the three battery voltage threshold levels, “half level”, “empty level”, and “shut level”, by 0.10 V, 0.10 V, and 0.22 V, respectively. The “half level” is a threshold level below which the battery remaining indicated on the LCD is reduced to half. The “empty level” is a threshold level below which the battery remaining indicated is reduced to one fourth. The “shut level” is a threshold level below which the power supply to the digital still camera is shut down. The “half level”, “empty level”, and “shut level” are generally called voltage check levels.

In the FIG. 16, when the projector is connected to the camera as the external equipment, the battery check level is set the same as that in the unconnected state. This is because the projector generally has a projector lamp which consumes a large amount of power so that the power supplied from the USB interface as small as 5V is insufficient to the projector, thus the projector needs a separate power supply, in other words, the projector is the self power supply type and needs to be supplied with little power from the digital still camera of the host side

In FIG. 16, the battery check level is changed only in accordance with the information on the type of the external equipments. More precisely, the digital processing circuit 7 preferably obtain the returned values of the current consumption from the Device Power of the Configuration Description of the USB specification and, in accordance with the returned values, set these values from the adequate battery check level table.

If the digital still camera has started to supply a lower power supply voltage, the camera body may start to operate unstably. In this case, the mouse or keyboard of the USB function is preferably supplied with no more power supply and disconnected from the digital camera. Specifically, the power supply can be stopped to the equipments which need the USB power supply when the shut down level as shown in FIG. 16 is reached. If necessary, the power supply to the digital still camera 20 can also be stopped.

In the above description, it has been supposed that the digital still camera is supplied with power from the built-in battery. If the digital camera is supplied with power from an external stable power source via an AC adaptor or the like, the power supply voltage should be stable unless a very large load is connected to the camera. Thus, for the equipments with lower electric power consumption of, for example, no more than 100 mA, the battery check level may be no changed, depending on the power supply design. The fact that the power supply is supplied from the AC adaptor or the like is determined by electrically detecting the fact that the connector of the AC adaptor is connected to the input terminal of the digital still camera.

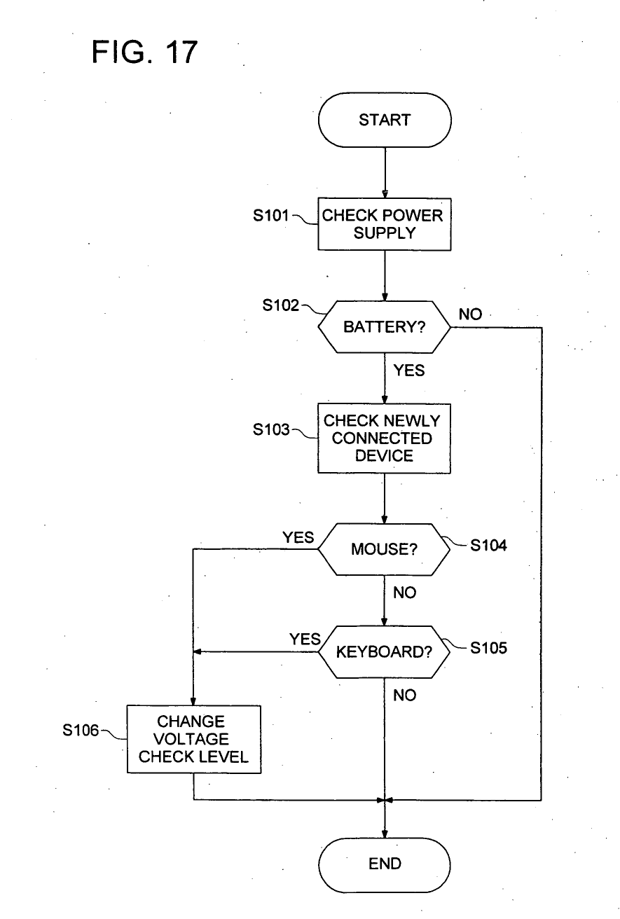

FIG. 17 shows a schematic diagram of a flowchart for changing a battery detection level according to the information on the connected external equipment. First, at the step S101, the digital processing circuit 7 detects the power supply state. At the step S102, it is judged whether the power is from the built-in battery or not. If the power is judged not to be from the built-in battery, the flow is terminated.

If the power supply is judged to be from the built-in battery, at the step S103 the digital processing circuit 7 detects the external equipments connected to the digital still camera. If the mouse is judged to be connected at the step S104, the digital processing circuit 7 changes the voltage check level at the step S106. If the keyboard is judged to be connected at the step S105, the digital processing circuit 7 changes the voltage check level at the step S106. The flow is then finished. The voltage check level may or may not be changed in each case, namely the mouse is connected, the keyboard is connected, or both are connected.

FIG. 10 shows a schematic diagram of an internal configuration of a projector 60 having USB connection capability according to the present invention. In the normal operation, a CRT output of the personal computer (not shown) sends RGB signals which are input as image data to a frame memory control circuit 62 via an AD converting circuit 61. In the frame memory control circuit 62, the incorporated image data are written to a frame memory 65. At the same time, the image data are read out from the frame memory 65 at the frame rate for display and sent to a liquid crystal display control circuit 63. In the liquid crystal display control circuit 63, the image data signals of each RGB channel are corrected to be suitable for the display characteristics. Thus, the transmissivities are changed for a liquid crystal plate for the R channel 64a, a liquid crystal plate for the G channel 64b, and a liquid crystal plate for the B channel 64c. The liquid crystal plates 64a 64c with varied transmissivities are incorporated in a projecting optical system 69 including a dichroic mirror. A white light lamp 68 activated by a light source circuit 67 emits a projecting light which is projected via a reflective optics and through each of the liquid crystal plates 64a˜64c.

To display images from the external host equipment (here a digital still camera 20) connected to the projector via USB interface, at first, the fact that the digital still camera 20 is connected to the projector 60 via a USB interface circuit 70 is detected by an internal sequence control CPU 71. The internal sequence control CPU 71 will then return to the digital still camera side 20 using Descriptor packet the information on resolution and the like of the projector 60 connected to the digital camera 20. The digital still camera 20 receives the information and the digital processing circuit (processing means) 7 in the camera 20 designates, as the predetermined processing, the resolution suitable for display on the projector 60. The above procedures are not described in detail here. This is because the procedures can be performed using general protocol procedures of USB and those skilled in the art can easily perform them according to Chapter 9 in the USB specification. A data input switching multiplexor circuit in the frame memory control circuit 62 is switched to the USB input side, waiting for the input data for display from the USB interface circuit 70. The image data is sent through the USB interface to the frame memory control circuit 62 where the image data is automatically transmitted to the frame memory 65. After the finish of the transmitting the image data according to the predetermined resolution or color number, the frame memory control circuit 62 notifies the finish to the internal sequence control CPU 71.

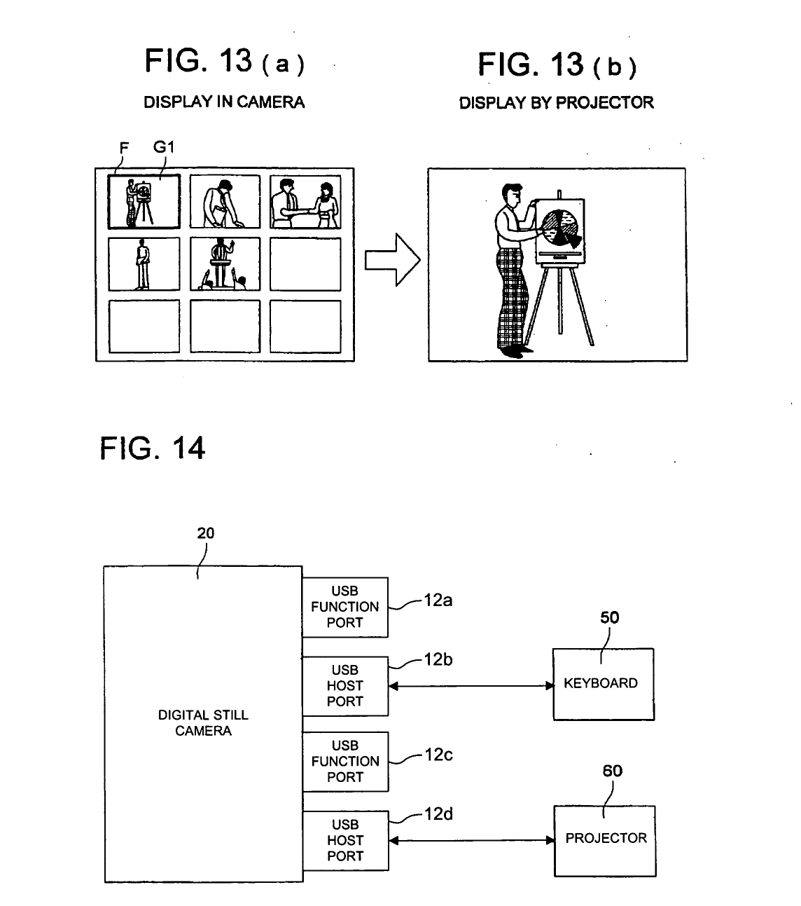

In the digital still camera 20, the digital processing circuit 7 can send the image data to the projector such that the projector can have a different display state from that of the built-in LCD 13b. For example, when the digital still camera 20 is able to index display more than one images on the liquid crystal display 28 according to the stored image data (see FIG. 13(a)), by index displaying on the digital still camera 20 and moving the control switch 29 as determination means on one direction to move an image frame F to select an image G1, the image data of a high definition image corresponding to the thumbnail image will be sent to the projector 60 and the image is projected as shown in FIG. 13 (b). Thus, the user can conveniently confirm the full-size images corresponding to the thumbnail images without displaying the full-sizes on the built-in LCD 28 of the digital still camera 20.

It will take time to perform the above procedures to switch the images projected by the projector 60. To reduce the time necessary for the switching, image data of the next image to be projected can previously be transmitted to the projector 60. This will be described specifically below.

In the internal sequence control CPU 71 in the projector 60, if there is a remaining frame memory for incorporating the images, the remaining frame memory and the frame memory volume necessary for the current resolution and color number are compared. If it is judged that the next image can be incorporated, it is notified to the digital still camera 20 that there is a remaining buffer memory to incorporate the next image to be displayed from the host side equipment.

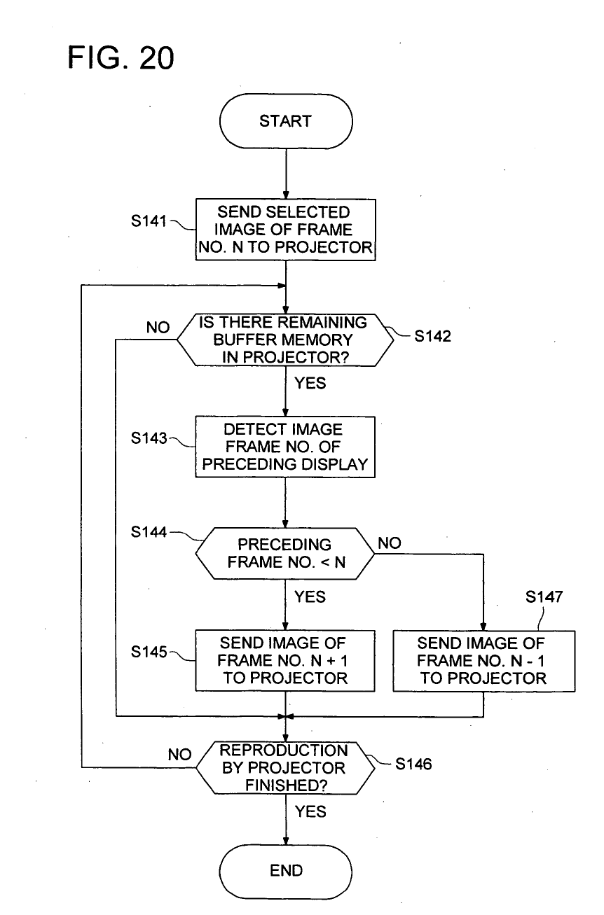

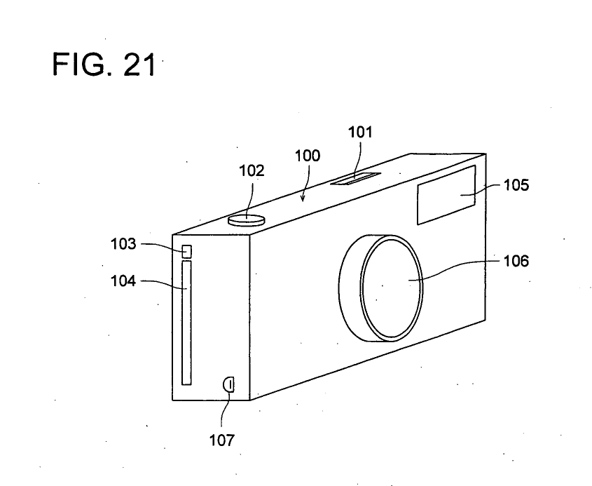

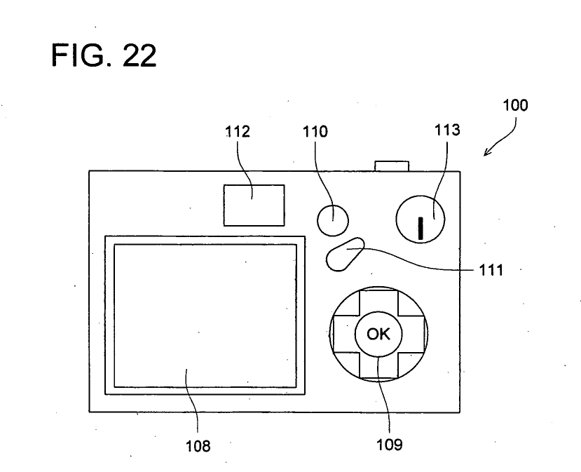

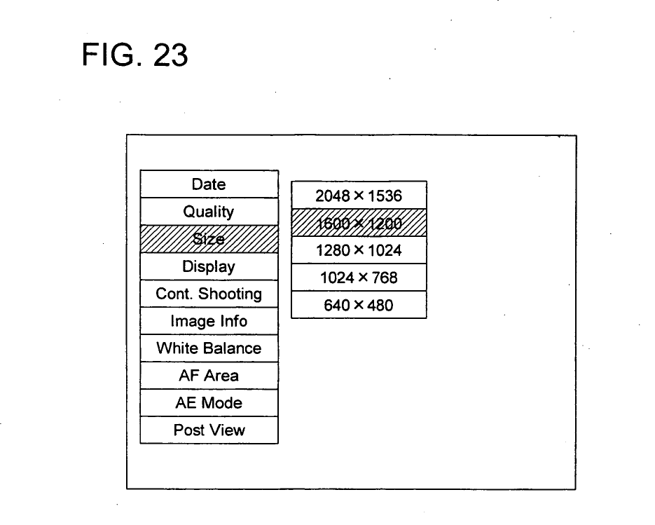

After receiving the notification that more image data can be sent to the projector 60, the digital still camera 20 sends image data of the image in addition to the image already sent to the projector 60 according to the flowchart shown in FIG. 20.

In FIG. 20 at the step S141, the digital process circuit 7 in the digital still camera 20 sends image data corresponding to the image G1 of the frame number N (which has a differently colored frame in the index display as shown in FIG. 13(a)) to the projector 60. The image G1 is selected by the operation of the five-way control button 29 combining the determination means and selection switch. After receiving the image data, the projector 60 can project the image G1 as shown in FIG. 13(b). At the step S142, the digital processing circuit 7 judges whether there is an enough buffer memory remaining 60 for storing the image data according to the information received from the internal sequence control CPU 71 in the projector 60. If the buffer memory remaining 60 is not sufficient, the digital processing circuit 7 waits for the finish of the reproduction of the image G1 at the step S146.

If the buffer remaining 60 is judged to be sufficient to store the image data, the digital processing circuit 7 detects the image frame number of the preceding display at the step S143. The circuit 7 then judges whether the preceding frame number is below N or not at the step S 144. This operation can predict the frame number of the next image to be projected according to the operation of the control switch 29. At the step S144, if the preceding frame number is judged not to be below N, at the step S147 the digital processing circuit 7 sends the image data of the image of the frame number N−1 to the projector 60. The projector 60 stores the image data in the buffer, and at the step S146 the digital processing circuit 7 waits for the finish of the reproduction of the image G1.

At the step S144, if the preceding frame number is judged to be below N, at the step S 145 the digital processing circuit 7 sends the image data of the image of the frame number N+1 to the projector 60. The projector 60 stores the image data in the buffer, and at the step S146 the digital processing circuit 7 waits for the finish of the reproduction of the image G1. In this way, the image data of the next image to be projected by the projector 60 can be previously stored in the buffer, and the time for switching images can be reduced. In other words, when the operation for displaying the next image is performed at the side of the host (digital still camera 20), an image switching command is sent to the projector 60 in response to the operation. On receiving the command, the internal sequence control CPU 71 can switch to the previously sent image to project it immediately. The buffer may store the image data of the frame number N+ (or −) 2 (or more or less) as well as N+ (or −) 1.

Using the above described function of previously sending an image different from the displayed image to the projector 60, for example, an image on the right side of the image selected by the digital still camera 20 can be previously sent during the display. Thus, the user can conveniently switch to the next image without waiting for data transfer.

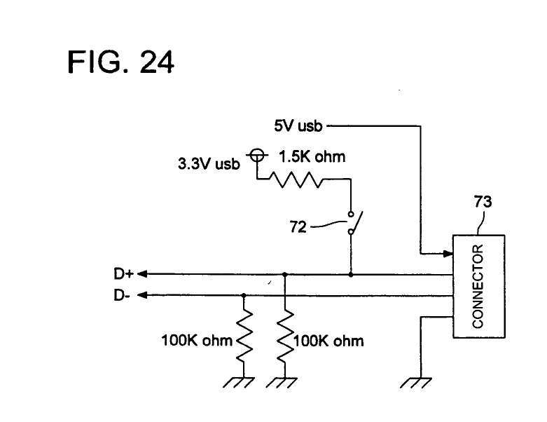

For the external equipments such as the projector 60 which consumes a large amount of power for the white light lamp, the power for the operation of the equipments is generally generated in the equipments and not incorporated from the USB interface side. In the present embodiment, the power including the power for the operation of the USB interface circuit 70 is incorporated from the internal power supply such as an AC power supply. Thus, as shown in FIG. 24, the switching means 72 is used to switch the pull-up resistance of the data line, which is used as connection notification means to the host side in response to the state of the power circuit 66.

FIG. 14 shows a schematic diagram of a digital still camera 20 with which a projector 60 and a keyboard 50 are connected. In FIG. 14, the digital still camera 20 serves as the host side and the projector 60 and keyboard 40 serve as the function side. In the Figure, the keyboard is used as a typical example, although the mouse, trackball, or track pad may also be used as the human interface equipments.

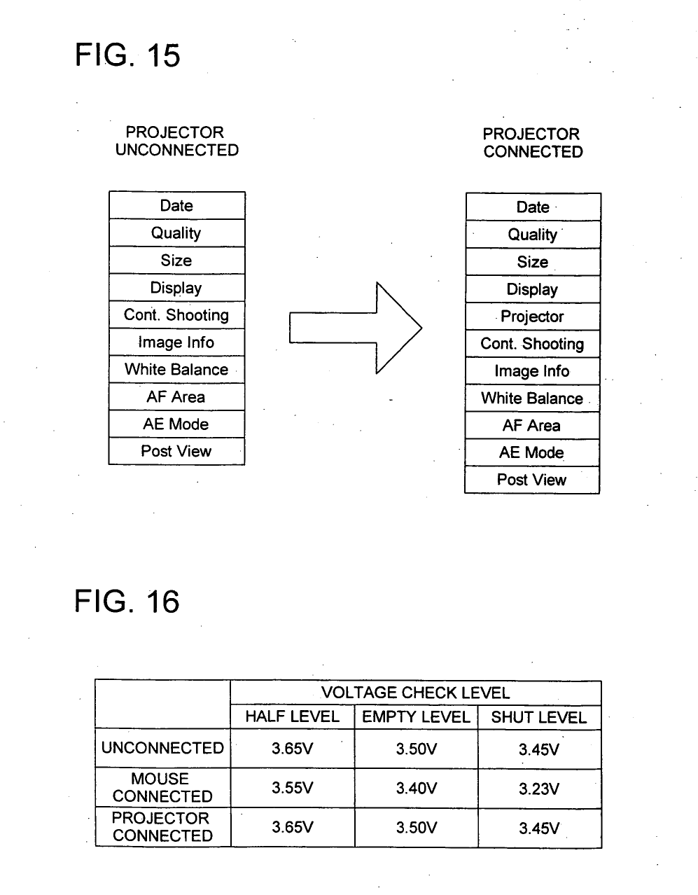

FIG. 15 shows a schematic diagram of an automatic change of a setting menu displayed on a built-in LCD when a projector is only connected to the digital still camera. Projector item (information on the projector setting) is added in the setting menu. In this item, for example, the control switch 29 can be used to set or change that the previous transfer of the image to the projector 60 is enable or disable. In the item, the zooming button (control switch) 33 of the digital still camera 20 can also be used to set or change the control of the zoom operation of the projector 60. If the projector 60 has a higher display resolution and more color numbers than the display ability of the digital still camera, the projector 60 can provided a higher definition display than the menu for the digital still camera 20. For example, the projector 60 can display kanji characters or high definition icons. Therefore, in this case, the menu displayed at the side of the projector 60 can be changed.

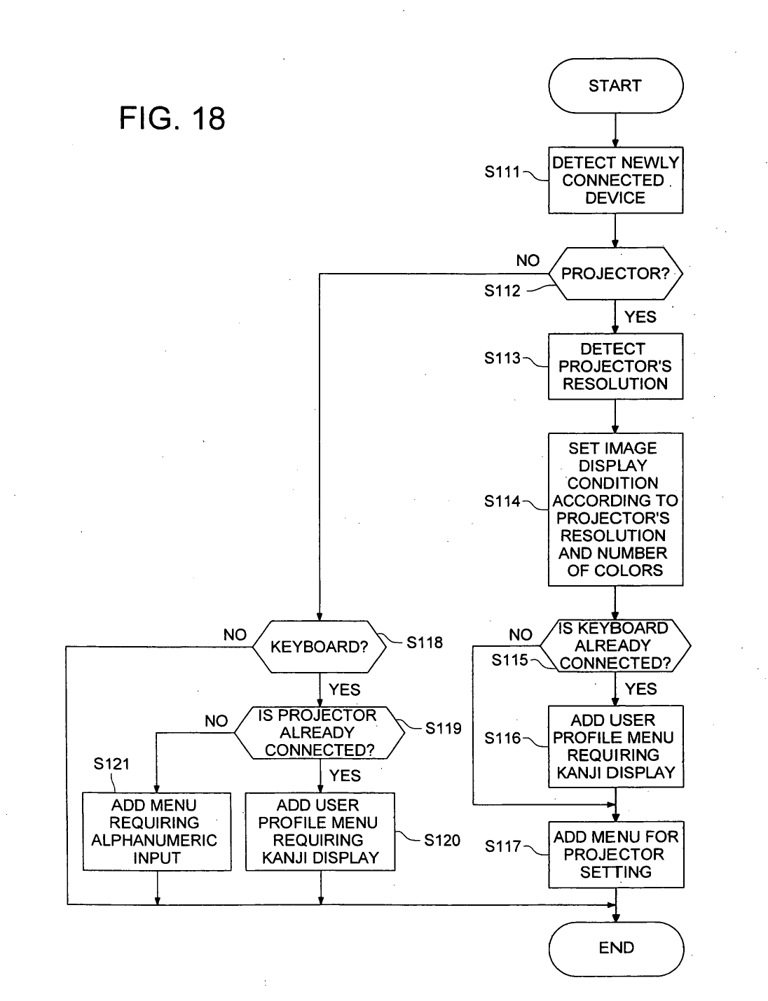

FIG. 18 shows a schematic diagram of a flowchart of control of acquiring information on displayable resolution and color number from a projector when the projector is connected to the digital still camera, and changing a menu displayed according to the information. In FIG. 18, at the step S111, the digital processing circuit 7 of the digital still camera 20 detects a newly connected external equipment. At the step S112, the digital processing circuit 7 judges whether the connected external equipment is the projector 60 or not. If the connected equipment is judged to be the projector 60, at the step S113 the digital processing circuit 7 acquires information on the displayable resolution and color number from the projector 60. Then, at the step S114, the digital processing circuit 7 of the processing means processes the image data in response to the displayable resolution and color number of the projector 60 according to the information acquired from the projector 60. The processed image data is subsequently sent to the projector 60. If the projector 60 has a plurality of displayable resolutions and color numbers, they can be displayed on the built-in LCD (display means) 28 of the digital still camera 20 and the user can select one of them by operating the selection means of the control switch 29.

At the step 115, the digital still camera 7 judges whether the keyboard 50 is connected to the digital still camera 20 or not. If the keyboard 50 is judged to be unconnected, at the step S117 the projector setting menu is added as shown in FIG. 15 and the flow is finished. If the keyboard 50 is judged to be connected to the digital still camera 20, at the step S116 the digital processing circuit 7 adds a User Profile menu requiring kanji character display and the flow is finished. By adding the User Profile menu requiring kanji character display, the kanji characters or the like entered from the keyboard 50 can be projected from the projector 60 along with the image.

At the step S112, if the digital processing circuit 7 judges that the connected external equipment is not the projector 60, at the step S118 the circuit 7 judges whether the keyboard 50 is connected or not. If the keyboard 50 is judged to be unconnected, the control flow is finished. If the keyboard 50 is judged to be connected, at the step S119 the digital processing circuit 7 judges whether the projector 60 is connected or not. At the step S120, if the projector 60 is judged to be connected, the User Profile menu requiring kanji character display is added and the flow is finished. If the projector 60 is judged to be unconnected, at the step S121 a menu requiring an alphanumeric input is added and the flow is finished.

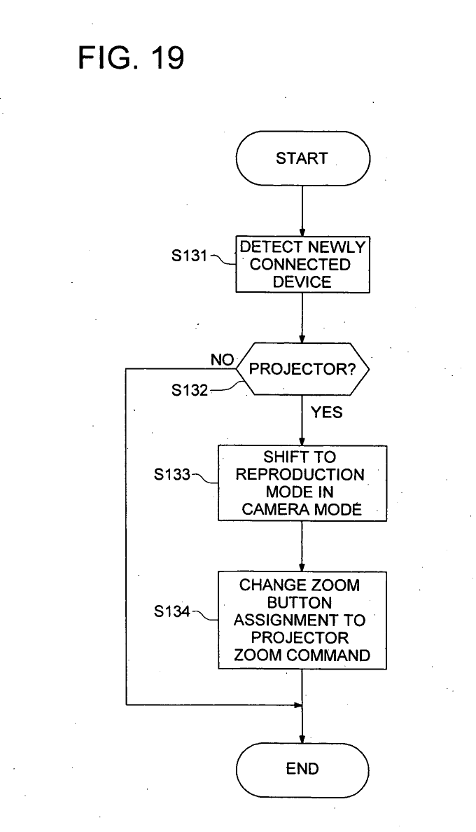

FIG. 19 shows a schematic diagram of a flowchart of control off detecting the projector connected to the digital still camera, and shifting to a reproduction mode in the camera mode and changing the zoom button assignment to a projector zoom command. In FIG. 19, at the step S131, the digital processing circuit 7 of the digital still camera 20 detects a newly connected external equipment. At the step S132, the digital processing circuit 7 judges whether the connected external equipment is the projector 60 or not. If the connected equipment is judged not to be the projector 60, the flow is finished. If the connected equipment is judged to be the projector 60, at the step S133 the digital processing circuit 7 of the digital still camera 20 sets the reproducing mode as a predetermined processing and serves as a control means. At the step S134, the operation assignment of the zoon button 33 (FIG. 3) is changed to a zoom command for the projector 60 and the setting changing flow is finished. From then on, the operation of the zoom button 33 on the digital still camera 20 can scale the image projected from the projector 60. The assignment of the zoom button 33 of the digital still camera 20 to the projector zoom function can be set in the setting menu in accordance with the user's preferences and can be skipped at the step S134.

Up to this point, the present invention has been described with reference to the preferred embodiments. The present invention is not limited to the above described embodiments and can be modified or improved as appropriate. For, example, the projector 60 can be incorporated into the digital still camera 20.

The present invention can provide an electronic camera which can improve an operability of the user interface without enlarging the body size or increasing the cost with a built-in large size display apparatus.

1-20. (canceled)

21. A photographing system, comprising:
an image acquisition device for acquiring an image data;
an image data provision device for providing an image data;
an interface connectable to an external display apparatus; and
a controller for controlling the external display apparatus,
wherein the controller is capable of controlling the external display apparatus when the interface is connected to the external display apparatus, and the image data provision device provides the acquired image data to the external display apparatus.

22. The photographing system of claim 21, wherein the controller is capable of controlling the external display apparatus so that the image displayed on the external display apparatus is enlarged or reduced.

23. The photographing system of claim 21, wherein the external display apparatus is a projector.

24. The photographing system of claim 21, wherein the external display apparatus is integrated into the photographing system.

25. The photographing system of claim 21, further comprising
a zoom switch for making a command to a zoom shot,
wherein when the interface is connected to the external display apparatus, the controller controls the external display apparatus to make the optical system of the external display apparatus move, in response to the command to a zoom shot from the zoom switch.

26. A photographing system, comprising:
an image acquisition device for acquiring an image data;
an image data provision device for providing an image data;
an interface connectable to an external display apparatus; and
a controller for forming a control command to control the external display apparatus,
wherein when the interface is connected to the external display apparatus, the image data provided by the image data provision device and the control command formed by the controller are sent to the external display device through the interface.

27. The photographing system of claim 26, wherein the external display device is a projector.
